(19) United States
(12) Patent Application Publication
(10) Pub. No.: US 2026/0302657 A1
(43) Pub. Date: Oct. 1, 2026

(54) TERMINAL BLOCK

(71) Applicant: DAIHEN CORPORATION, Osaka (JP)

(72) Inventors: Ryota KISHIMOTO, Osaka (JP); Yuichi Hasegawa, Osaka (JP)

(21) Appl. No.: 19/563,633

(22) Filed: Mar. 11, 2026

(30) Foreign Application Priority Data
Mar. 31, 2025 (JP) 2025-057546

(51) Int. Cl. H01R 9/24; H01R 4/34

(52) U.S. Cl. CPC H01R 9/2416; H01R 4/34

(57) ABSTRACT

A terminal block includes a block main body made of insulating material and a conductive support made of metal that is attached to an end face of the block main body and supports and fixes a pair of connection terminals. The conductive support includes a plate portion attached to the end face of the block main body along the end face; a support pole portion provided upright from the plate portion to support the connection terminals; and a fastener that fixes the connection terminals to the support pole portion so as to sandwich the connection terminals between the plate portion and the fastener by being screwed to the support pole portion.

### RELATED APPLICATIONS

The present application claims priority to Japanese Patent application No. JP2025-057546, filed on Mar. 31, 2025, the entire content of which is incorporated herein by reference.

### BACKGROUND OF THE INVENTION

### 1. Field of the Invention

The present invention relates to a terminal block that electrically connects a pair of connection terminals.

### 2. Description of the Related Art

As a technique of this type, for example, JP 7607996 B discloses a terminal block in which a pair of connection terminals is secured to a block main body. The block main body is made of an insulating resin material and has a threaded hole. By screwing a screw into the threaded hole of the block main body, the connection terminals are secured to the block main body so as to be sandwiched between a screw head and the block main body.

### SUMMARY OF THE INVENTION

In general, however, a potential difference exists between the connection terminals and the block main body, and thus an electric field tends to concentrate at the tip portion of the screw in contact with the connection terminals. Thus, corona discharge may occur when a slight gap exists between the tip portion of the screw and the bottom surface of the threaded hole of the block main body. Such corona discharge may damage the block main body made of a resin material.

The present invention has been made in view of the foregoing, and provides a terminal block that can suppress damage of the block main body for securing connection terminals due to corona discharge.

In view of the above-described issue, the terminal block according to the present invention is a terminal block that electrically connects a pair of connection terminals, the terminal block including at least: a block main body made of an insulating resin material; and a conductive support that is attached to an end face of the block main body and supports and fixes the pair of connection terminals, the conductive support being made of a metal material. The conductive support includes: a plate portion that is attached to the end face of the block main body along the end face; a support pole portion provided upright from the plate portion to support the connection terminals; and a fastener that fixes the connection terminals to the support pole portion so as to sandwich the connection terminals between the plate portion and the fastener by being screwed to the support pole portion.

According to the present invention, in a state where the connection terminals are supported on the support pole portion provided upright from the plate portion, it is possible to screw the fastener to the support pole portion and sandwich the connection terminals between the plate portion and the fastener. This can fix the connection terminals to the support pole portion. Further, the plate portion is attached to the end face of the block main body along the end face, and there is no need to provide the support pole portion of the conductive support directly upright from the block main body, and thus, it is possible to suppress occurrence of corona discharge between the conductive support and the block main body, and prevent damage of the block main body made of resin due to corona discharge.

In a preferred aspect, the plate portion includes a through-hole, and the support pole portion includes a fixed part that is fixed to the plate portion by being press-fit into the through-hole, and a threaded part that is continuous from the fixed part and screwed into the fastener.

According to this aspect, since the fixed part of the support pole portion is press-fit into the plate portion, it is possible to stably provide the support pole portion upright with respect to the plate portion. Accordingly, no threaded part need be formed on the peripheral surface of the fixed part of the support pole portion. This can prevent a phenomenon in which an electric field excessively concentrates at the tip of the threaded part and can suppress corona discharge from the fixed part.

In a more preferred aspect, the support pole portion includes a projection that is continuous to the fixed part and projects in a disc shape from a surface among surfaces of the plate portion that faces an end face of the block main body. The end face of the block main body includes a cylindrical recessed portion having a diameter greater than a diameter of the projection and a depth greater than a height of the projection. The projection is housed in the recessed portion without contacting a wall surface of the recessed portion.

According to this aspect, since the disc-shaped projection is housed in the recessed portion without contacting the wall surface of the recessed portion, it is possible to disperse the electric field from the connection terminals over the peripheral edge of the end face of the projection. Thus, it is possible to prevent corona discharge between the conductive support and the block main body.

In a more preferred aspect, the plate portion includes an insertion hole into which a screw made of resin is inserted. The end face of the block main body includes a threaded hole that is screwed to the screw, and in a state where the screw is inserted, the plate portion is fixed to the block main body by screwing the screw into the threaded hole.

According to this aspect, in a state where the screw made of a resin material is inserted, the plate portion is fixed to the block main body by screwing the screw into the threaded hole, and thus an electric field will not concentrate at the tip portion of the resin screw. Thus, it is possible to prevent corona discharge between the conductive support and the block main body.

In a more preferred aspect, the plate portion is made of copper or a copper alloy, and the support pole portion is made of stainless steel.

According to this aspect, the plate portion made of copper or a copper alloy can increase electroconductivity between the connection terminals and can reduce resistive heating in the plate portion. Further, the support pole portion made of stainless steel can increase strength of the support pole portion as compared to the support pole portion made of copper or a copper alloy. Consequently, even if the fastener is screwed to the support pole portion and excessively tightened, it is possible to prevent plastic deformation and crushing of the ridge of the support pole portion.

According to the present invention, it is possible to suppress damage of the block main body for securing connection terminals due to corona discharge.

### BRIEF DESCRIPTION OF THE DRAWINGS

FIG. 1 is a schematic perspective view of a terminal block according to the present embodiment of the present invention.

FIG. 2 is an exploded perspective view of the terminal block shown in FIG. 1.

FIG. 3A is a schematic perspective view of a conductive support.

FIG. 3B is a schematic perspective view of the conductive support of FIG. 3A as viewed from the back surface.

FIG. 3C is an exploded perspective view of the conductive support of FIG. 3A.

FIG. 4A is a cross-sectional view of the terminal block of FIG. 1 as viewed in the direction of the arrow along line A-A.

FIG. 4B is a cross-sectional view of the terminal block of FIG. 1 as viewed in the direction of the arrow along line B-B.

FIG. 5 is an enlarged cross-sectional view of the main part of FIG. 4A.

FIG. 6 is an exploded perspective view of a terminal block according to a modification.

### DETAILED DESCRIPTION OF THE PREFERRED EMBODIMENTS

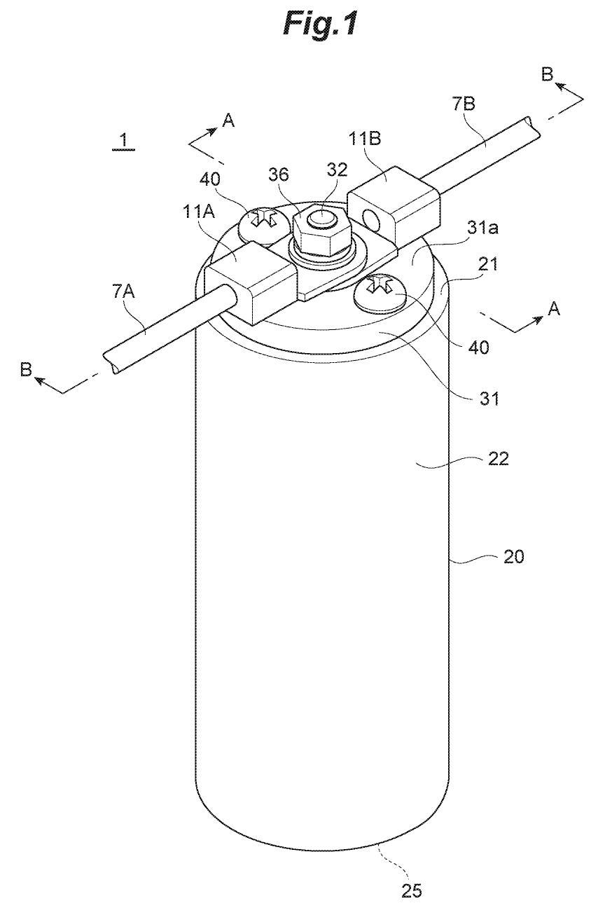

Hereinafter, with reference to FIGS. 1-6, a terminal block 1 according to the present embodiment and a terminal block 1A according to a modification thereof will be described.

As shown in FIG. 1, the terminal block 1 electrically connects a pair of connection terminals 11A, 11B. The connection terminal 11A (11B) is attached to an end of a high-voltage cable 7A (7B) for several tens of kV. The high-voltage cables 7A, 7B can be electrically connected to each other by bringing the connection terminals 11A, 11B into contact using the terminal block 1 or indirectly conducting the connection terminals 11A, 11B via the terminal block 1.

In the present embodiment, the connection terminal 11A (11B) is a round type crimp terminal made of a metal material such as aluminum. Note that the connection terminal 11A (11B) may be, for example, a Y type crimp terminal or a CB type crimp terminal. The shape of the connection terminal 11A (11B) is not particularly limited as long as the connection terminals 11A, 11B can be directly or indirectly connected using the terminal block 1.

The connection terminal 11A (11B) includes a wire fixed portion 12A (12B) that is fixed to the end of the high-voltage cable 7A (7B) and a terminal connecting portion 13A (13B) that electrically connects the connection terminal 11A (11B) to a mating connection terminal 11B (11A).

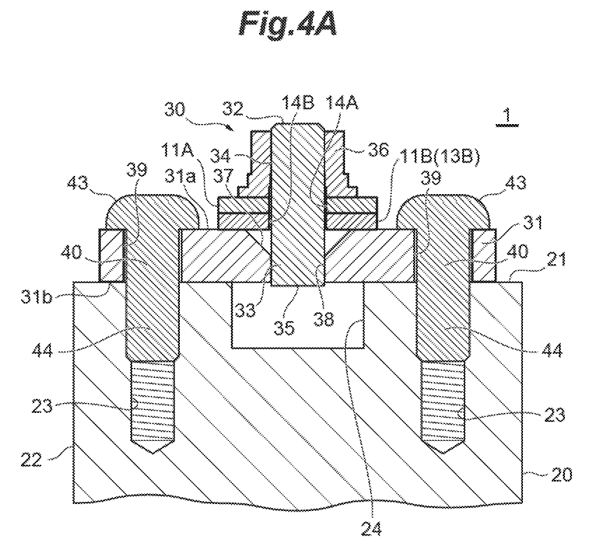

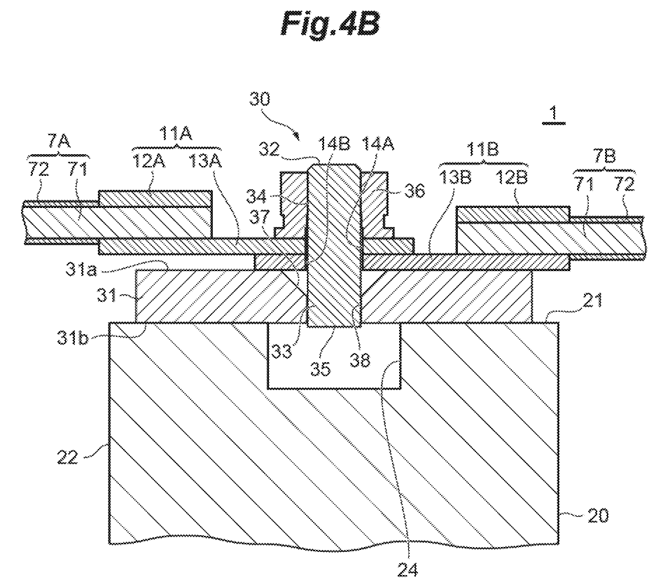

In the present embodiment, the wire fixed portion 12A (12B) is block-shaped but may have a cylindrical shape. In the present embodiment, the block-shaped wire fixed portion 12A (12B) includes a hole into which an electric wire 71 of the high-voltage cable 7A (7B) is inserted. As shown in FIG. 4B, the wire fixed portion 12A (12B) fixes the electric wire 71 by swaging or the like while housing the electric wire 71 exposed from an insulating film 72 at an end portion of the high-voltage cable 7A (7B). The terminal connecting portion 13A (13B) is formed to be continuous from the wire fixed portion 12A (12B).

The terminal connecting portion 13A (13B) includes an insertion portion 14A (14B) into which a support pole portion 32 (described later) is inserted. In the present embodiment, the connection terminal 11A (11B) is a round type crimp terminal, and thus the outside shape of the terminal connecting portion 13A (13B) is substantially ring-shaped, and the terminal connecting portion 13A (13B) includes the circular insertion portion 14A (14B) at the center. For example, when the connection terminal 11A (11B) is a Y type crimp terminal, the terminal connecting portion 13A (13B) includes a U-shaped insertion portion.

The terminal block 1 includes a block main body 20 and a conductive support 30. The block main body 20 is provided upright inside of a grounded housing (not shown), for example. Inside the housing, a device (not shown) or a substrate (not shown) connected to each of the high-voltage cables 7A, 7B is housed. The block main body 20 is columnar and in the present embodiment, the block main body 20 is cylindrical.

The block main body 20 is secured to the housing in a state where an end face 25 on one side of the block main body 20 abuts on the housing. The block main body 20 includes a side surface 22 extending from the end face 25 on one side of the block main body 20 from an end face 21 on the other side of the block main body 20. Since the side surface 22 is a peripheral surface without a corner, corona discharge is less likely to occur between a high-voltage component (not shown) or the like inside of the housing and the side surface 22.

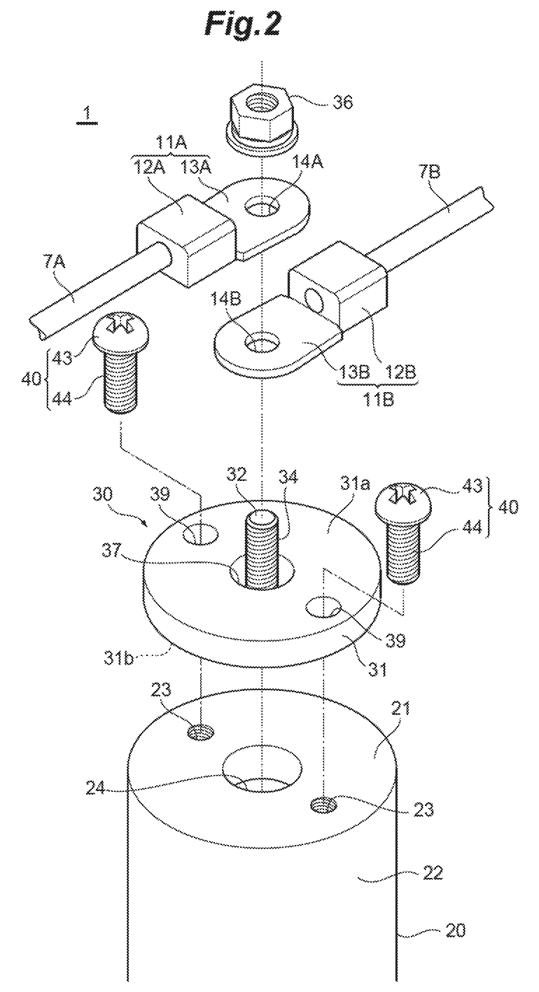

As shown in FIG. 2, the end face 21 on the other side of the block main body 20 is circular. The end face 21 of the block main body 20 includes a cylindrical recessed portion 24 at the center. Further, the end face 21 of the block main body 20 includes a pair of threaded holes 23 for attaching the conductive support 30 at the positions sandwiching the recessed portion 24. An inner peripheral surface of the threaded hole 23 includes an internal thread that is screwed to a shank 44 (or an external thread thereof) of a screw 40.

The block main body 20 is made of an insulating resin material. Any insulating resin material may be used for the block main body 20, but a resin material with insulation, heat resistance, and withstand voltage is preferable.

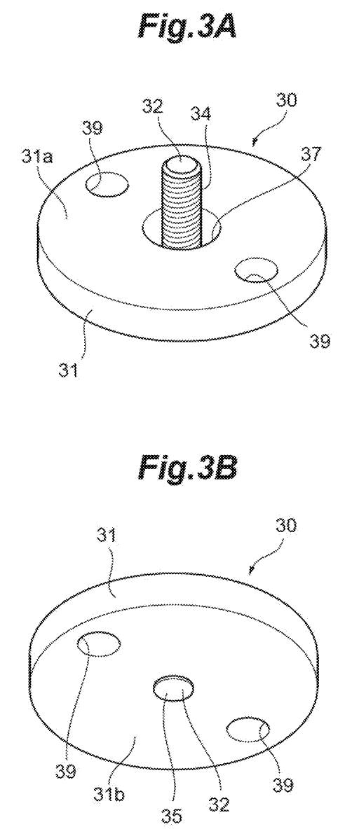

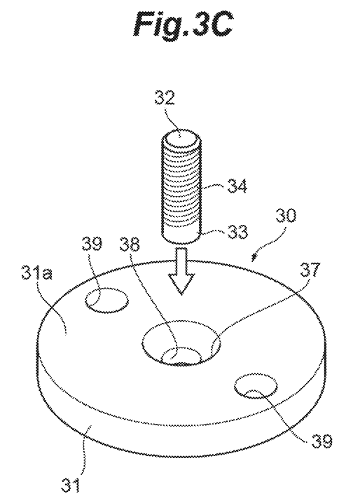

In the present embodiment, the conductive support 30 is attached to the end face 21 of the block main body 20. The conductive support 30 is used to support and fix the pair of connection terminals 11A, 11B. The conductive support 30 is made of a metal material. As shown in FIGS. 2 and 3A-3C, the conductive support 30 includes a plate portion 31 that is attached to the end face 21 of the block main body 20 along the end face 21 and the support pole portion 32 provided upright from the plate portion 31 to support the connection terminals 11A, 11B.

The plate portion 31 is disc-shaped and includes a cylindrical through-hole 38 at the center. A surface 31a among the surfaces of the plate portion 31 on the side where the support pole portion 32 is provided upright includes a tapered surface 37 formed along an opening edge of the through-hole 38.

The plate portion 31 includes a pair of insertion holes 39 into which the screw 40 made of a resin material is inserted. The pair of insertion holes 39 is formed at positions sandwiching the through-hole 38. The insertion holes 39 are formed such that in a state where the plate portion 31 is disposed on the end face of the block main body 20, each of the insertion holes 39 is continuous to the threaded hole 23 on the end face 21 of the block main body 20.

The screw 40 is made of an insulating resin material. The insulating resin material is not particularly limited, and may include fluorine resin, for example. The screw 40 includes a head 43 that engages with a tip of a tool such as a driver, and a shank 44 extending from the head 43. The shank 44 includes an external thread. In a state where the screw 40 is inserted into each of the insertion holes 39, the plate portion 31 is fixed to the block main body 20 by screwing the shank 44 of the screw 40 into the threaded hole 23 of the block main body 20 and tightening the screw 40.

As shown in FIG. 3C, the support pole portion 32 is a cylindrical shaft, and is fixed to the plate portion 31 by being press-fit into the through-hole 38. The support pole portion 32 includes a fixed part 33 that is fixed to the plate portion 31 and a threaded part 34 that is continuous from the fixed part 33 and screwed into a fastener 36. The threaded part 34 is provided upright from the plate portion 31 on the side of the surface 31a of the plate portion 31, and the peripheral surface of the threaded part 34 includes an external thread that is screwed into the fastener 36.

Note that the threaded part 34 may have any area of an external thread as long as the pair of connection terminals 11A, 11B can be crimped by tightening the fastener 36. Therefore, in a state where the pair of connection terminals 11A, 11B is attached, the threaded part 34 may have a cylindrical surface where an external thread is not formed between the surface facing the insertion portions 14A, 14B of the pair of connection terminals 11A, 11B and the surface facing the tapered surface 37 (described later).

The fixed part 33 of the support pole portion 32 is a cylindrical portion and is press-fit into the through-hole 38 of the plate portion 31. This allows the support pole portion 32 to be stably provided upright with respect to the plate portion 31. In the present embodiment, the support pole portion 32 is fixed by press fitting, and thus no threaded part need be formed on the peripheral surface of the fixed part 33 of the support pole portion 32. This can prevent an electric field from excessively concentrating on the surface of the fixed part 33 and can suppress corona discharge from the fixed part 33.

The plate portion 31 and the support pole portion 32 are made of a metal material and are not particularly limited as long as they are made of a conductive material, but the plate portion 31 is preferably made of copper or a copper alloy and the support pole portion 32 is preferably made of stainless steel.

The plate portion 31 made of copper or a copper alloy can increase electroconductivity between the connection terminals 11A, 11B and can reduce resistive heating in the plate portion 31. Further, the support pole portion 32 made of stainless steel can increase strength of the support pole portion 32 as compared to the support pole portion 32 made of copper or a copper alloy. Consequently, even if the fastener 36 is screwed to the support pole portion 32 and excessively tightened, it is possible to prevent plastic deformation and crushing of the ridge of the threaded part 34 of the support pole portion 32.

As shown in FIGS. 4A and 4B, the support pole portion 32 includes a projection 35 that is continuous to the fixed part 33. The projection 35 is a disc-shaped portion projecting from a surface (back surface) 31b among the surfaces of the plate portion 31 that faces the end face 21 of the block main body 20. With the conductive support 30 attached to the end face 21 of the block main body 20 by the pair of screws 40, the projection 35 is housed in the cylindrical recessed portion 24 formed on the end face 21 of the block main body 20.

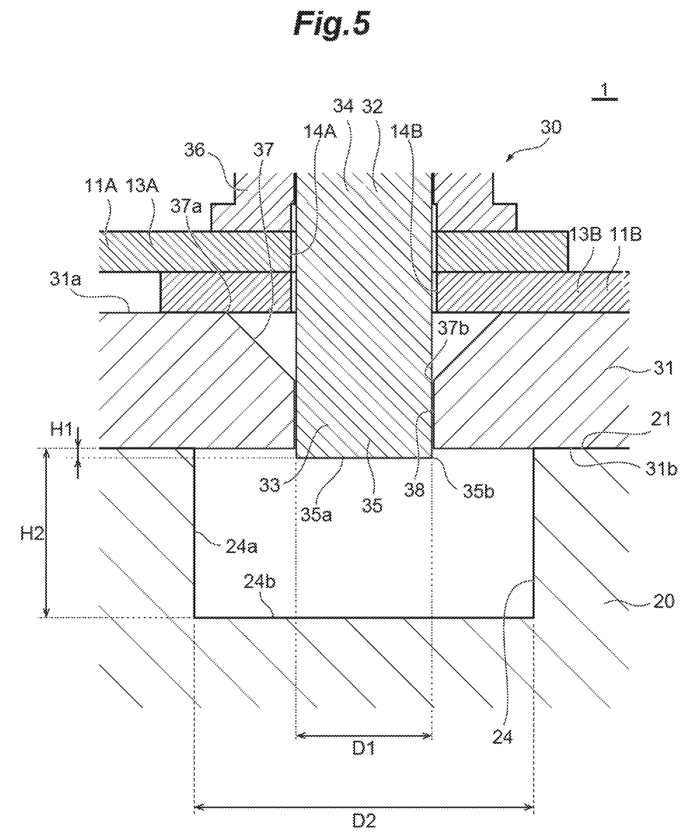

In the present embodiment, in a state where the conductive support 30 is attached to the block main body 20, the axis of the support pole portion 32 coincides with the axis of a cylinder that is the shape of the recessed portion 24. As shown in FIG. 5, the recessed portion 24 has a diameter D2 greater than a diameter D1 of the projection 35 and has a depth H2 greater than a height H1 of the projection 35. With this configuration, the projection 35 is housed in the recessed portion 24 without contacting wall surfaces 24a, 24b of the recessed portion 24.

Note that it is structurally difficult to align the surface (back surface) 31b of the plate portion 31 to be flush with an end face 35a of the projection 35, and usually the end face 35a of the support pole portion 32 protrudes from the surface (back surface) 31b of the plate portion 31 or is recessed.

As described above, the fixed part 33 of the support pole portion 32 is press-fit into the through-hole 38 of the plate portion 31, and thus in order to secure the mechanical strength, preferably, the end face 35a of the support pole portion 32 rather protrudes from the surface (back surface) 31b of the plate portion 31.

When the end face 35a of the support pole portion 32 protrudes from the surface (back surface) 31b of the plate portion 31, this protruding portion is formed as the projection 35, which means that the recessed portion 24 need be provided. Here, when the end face 35a of the support pole portion 32 protrudes from the surface (back surface) 31b of the plate portion 31, an electric field concentrates at a corner of the projection 35. In this state, a short distance among the corner of the projection 35, the block main body 20, and the wall surfaces 24a, 24b of the recessed portion 24 may generate corona discharge. In order to prevent corona discharge, a large distance is preferably set among the corner of the projection 35 of the support pole portion 32, the block main body 20, and the wall surfaces 24a, 24b of the recessed portion 24. An appropriate value of this distance differs depending on the magnitude of the voltage applied and the like, and thus may be designed in accordance with the actual circumstances through experiments and the like.

The conductive support 30 further includes the fastener 36. The fastener 36 is a nut made of a metal material such as stainless steel or aluminum. As shown in FIGS. 4A and 4B, the fastener 36 fixes the connection terminals 11A, 11B to the support pole portion 32 so as to sandwich the connection terminals 11A, 11B between the plate portion 31 and the fastener 36 by being screwed to the support pole portion 32.

According to the present embodiment, as shown in FIGS. 2 and 4A, in a state where the pair of screws 40 is inserted into the insertion holes 39 of the plate portion 31, the shank 44 of each of the screws 40 is screwed into the threaded hole 23 of the block main body 20 and tightened. Accordingly, the conductive support 30 can be attached to the block main body 20 such that the plate portion 31 is sandwiched between the head 43 of each of the screws 40 and the block main body 20 and the plate portion 31 is fixed to the block main body 20.

In the present embodiment, the block main body 20 and the screw 40 are made of a resin material, and thus an electric field will not concentrate at the tip portion of the external thread of the shank 44 of the screw 40. Accordingly, in the inner space of the threaded hole 23, it is possible to prevent corona discharge between the conductive support 30 and the block main body 20.

In this attached state, the support pole portion 32 provided upright from the plate portion 31 is inserted through the insertion portions 14A, 14B of the connection terminals 11A, 11B in this order to have the connection terminals 11A, 11B supported on the support pole portion 32. In this supported state, the fastener 36 is screwed to the support pole portion 32 and tightened. Accordingly, the terminal connecting portions 13A, 13B stacked together are sandwiched between the plate portion 31 and the fastener 36.

This allows the pair of the connection terminals 11A, 11B to be fixed to the support pole portion 32 in a state where the pair of the connection terminals 11A, 11B (the terminal connecting portions 13A, 13B) is crimped together. Consequently, the high-voltage cables 7A, 7B are electrically connected together via the pair of the connection terminals 11A, 11B.

In the present embodiment, the support pole portion 32 inserted through the insertion portions 14A, 14B of the terminal connecting portions 13A, 13B is also made of a metal material, and the fastener 36 and the plate portion 31 sandwiching the terminal connecting portions 13A, 13B are also made of a metal material. This can increase electroconductivity between the connection terminals 11A, 11B and can stably secure electrical connection between the high-voltage cables 7A, 7B.

Furthermore, as shown in FIGS. 4B and 5, the plate portion 31 is attached to the end face 21 of the block main body 20 along the end face 21, and there is no need to screw to the block main body 20 a threaded shaft or the like corresponding to the support pole portion 32 and provide it directly upright from the block main body 20. Thus, it is possible to suppress occurrence of corona discharge between the conductive support 30 and the block main body 20, and prevent damage of the block main body 20 made of a resin material due to corona discharge.

Furthermore, in the present embodiment, the tapered surface 37 is formed on the surface 31a of the plate portion 31 along the opening edge of the through-hole 38. The reason for this will be described. If the tapered surface 37 is not formed, press-fitting the support pole portion 32 as shown in FIG. 3C may cause a contact portion between the plate portion 31 and the support pole portion 32 to swell such that the connection terminal 11B will not be flush in contact with the surface 31a of the plate portion 31, causing a small gap between the connection terminal 11B and the plate portion 31. Since such a small gap portion includes an air layer, a potential is generated, making it appear electrically resistive. Thus, heating may occur when electric current flows. In contrast, if the tapered surface 37 is formed as in the present embodiment, even if the support pole portion 32 is press-fit, it is possible to prevent the connection terminal 11B from not being flush in contact with the surface 31a of the plate portion 31 due to deformation of the plate portion 31 and prevent formation of a small gap between the connection terminal 11B and the plate portion 31. For this reason, unlike the case where the tapered surface 37 is not formed, heating will not occur.

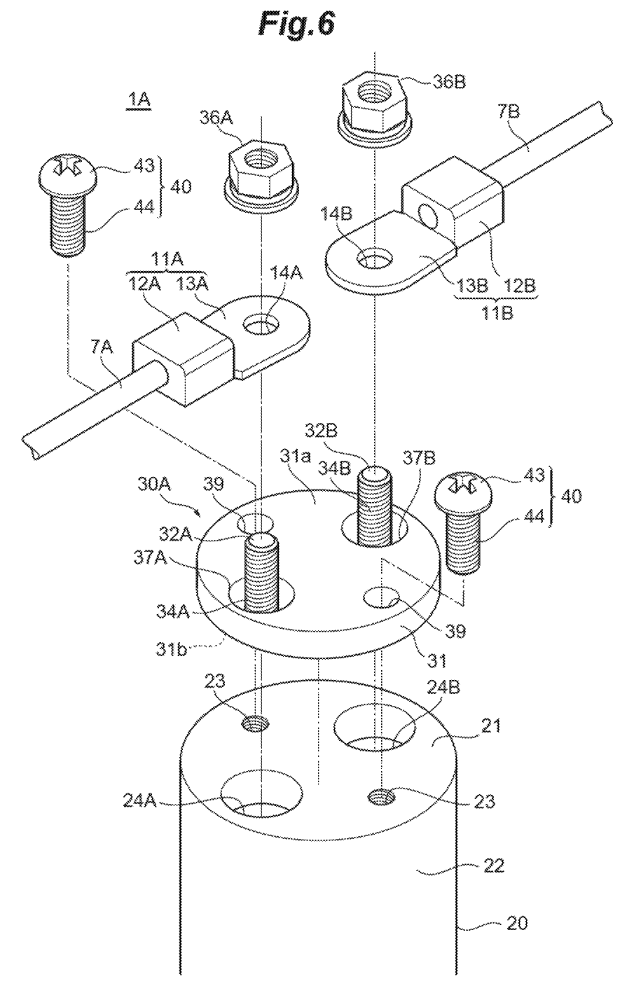

FIG. 6 is an exploded perspective view of a terminal block 1A according to a modification. In the embodiments shown in FIGS. 1-5, one support pole portion 32 is provided for a conductive support 30A. However, for example, as in the modification shown in FIG. 6, a support pole portion 32A (32B) may be provided for the conductive support 30A for each of the connection terminal 11A (11B). Each support pole portion 32A (32B) is press-fit into a through-hole formed in the conductive support 30A, and has a threaded part 34A (34B) that is screwed into fasteners 36A, 36B. Also in this modification, like the above-described present embodiment, tapered surfaces 37A, 37B are formed along the opening edges of the through-holes.

In the same manner, each support pole portion 32A (32B) has a projection (not shown) projecting from a surface (back surface) 31b the plate portion 31. Each projection is housed in a recessed portion 24A (24B) formed on the end face 21 of the block main body 20. According to this modification, it is possible to electrically connect the connection terminals 11A, 11B via the plate portion 31 of the conductive support 30A without stacking together the connection terminals 11A, 11B.

Although the embodiments of the present invention have been described in detail above, the present invention is not limited to the above embodiments, and various design changes are possible in so far as they are within the spirit of the present invention in the scope of the claims.

In the present embodiment and the modification thereof, fixing the conductive supports 30, 30A to the block main body 20 by means of the screws 40 can stably bind the conductive supports 30, 30A with the block main body 20 regardless of a thermal expansion difference between the conductive supports 30, 30A and the block main body 20. However, when a heating amount or the like of these members are small, the conductive supports 30, 30A may be adhered to the block main body 20 by an adhesive or the like.

In addition, in the present embodiment and the modification thereof, the block main body 20 is, but not limited to, cylindrical. For example, the cylindrical surface may include a step with alternating small and large diameters with a large creepage distance between the end face 25 and the end face 21 that are opposite faces of the block main body 20, so that corona discharge is less likely to occur between the conductive support 30 and the housing.

What is claimed is:

1. A terminal block that electrically connects a pair of connection terminals,
the terminal block comprising at least:
a block main body made of an insulating resin material; and
a conductive support that is attached to an end face of the block main body and supports and fixes the pair of connection terminals, the conductive support being made of a metal material,
wherein the conductive support includes:
a plate portion that is attached to the end face of the block main body along the end face;
a support pole portion provided upright from the plate portion to support the connection terminals; and
a fastener that fixes the connection terminals to the support pole portion so as to sandwich the connection terminals between the plate portion and the fastener by being screwed to the support pole portion.

2. The terminal block according to claim 1,
wherein the plate portion includes a through-hole, and
wherein the support pole portion includes
a fixed part that is fixed to the plate portion by being press-fit into the through-hole, and
a threaded part that is continuous from the fixed part and screwed into the fastener.

3. The terminal block according to claim 2,
wherein the support pole portion includes a projection that is continuous to the fixed part and projects in a disc shape from a surface among surfaces of the plate portion that faces an end face of the block main body,
wherein the end face of the block main body includes a cylindrical recessed portion having a diameter greater than a diameter of the projection and a depth greater than a height of the projection, and
wherein the projection is housed in the recessed portion without contacting a wall surface of the recessed portion.

4. The terminal block according to claim 1,
wherein the plate portion includes an insertion hole into which a screw made of a resin material is inserted,
wherein the end face of the block main body includes a threaded hole that is screwed to the screw, and
wherein in a state where the screw is inserted, the plate portion is fixed to the block main body by screwing the screw into the threaded hole.

5. The terminal block according to claim 2, wherein
the plate portion is made of copper or a copper alloy, and
the support pole portion is made of stainless steel.
